(19) United States
(12) Patent Application Publication
(10) Pub. No.: US 2026/0327045 A1
(43) Pub. Date: Oct. 22, 2026

(54) DEVICE FOR REMOVING FLUIDS AND DIRT

(71) Applicant: Inventio AG, Hergiswil (CH)

(72) Inventor: Georg Wagenleitner, Roßleithen (AT)

(21) Appl. No.: 19/122,077

(22) PCT Filed: Dec. 5, 2023
(86) PCT No.: PCT/EP2023/084211

§ 371 Date: Apr. 17, 2025

(30) Foreign Application Priority Data
Dec. 7, 2022 (EP) 22211964.6

(51) Int. Cl. B66B 31/02; B66B 23/24; B66B 25/00; B66B 27/00

(52) U.S. Cl. CPC B66B 31/02; B66B 23/24; B66B 25/006; B66B 27/00

(57) ABSTRACT

The disclosure relates to a device for removing fluids and dirt from a moving handrail of an escalator or a moving walkway. The device has a mounting device, a wheel body with a compressible, absorbent pad, a squeezing roller, a wheel axle, and a roller axle, wherein the wheel body and the squeezing roller are rotatably mounted in the mounting device using the wheel axle and the roller axle respectively. An axial distance between the wheel axle and the roller axle is specified in such a way that the absorbent pad of the wheel body is compressed in a contact zone between the wheel body and the squeezing roller.

The present disclosure relates to a device for removing fluids and dirt from moving handrails of an escalator or moving walkway.

Escalators and moving walkways are used to transport people and carry objects in buildings such as train stations, subway stations, airports, shopping centers, department stores and the like. For transportation purposes, escalators and moving walkways have a revolving conveyor belt that can be walked on. To ensure that people can protect themselves against falls while traveling, escalators and moving walkways have balustrades on both sides of the conveyor belt, on each of which a handrail is arranged in a revolving manner. The two handrails must be driven at a synchronous speed to the conveyor belt in accordance with relevant standards, such as EN115. Handrails usually have a C-shaped cross-section. The forward run of the handrail is guided by means of a T-shaped guide profile which is rigidly attached to the balustrade. The return of the return run takes place in a manner hidden from the people, within a balustrade base of the balustrade.

As disclosed in EP 2 931 645B1 , for example, a handrail is driven by means of a handrail drive wheel which is arranged inside the escalator or moving walkway. Said handrail drive wheel transmits its drive torque and drive movement to an inner side of the C-shaped handrail by means of frictional engagement. As long as the escalator or moving walkway is installed indoors in a manner protected from the effects of weather, there are hardly any problems in terms of the traction between the handrail and the handrail drive wheel. In the case of escalators and moving walkways that are used entirely or partially outdoors, a relatively large amount of fluid, in particular water, may accumulate on the inner side of the C-shaped handrail in rainy weather and may significantly change the friction conditions between the handrail drive wheel and the handrail. This may result in slip-stick effects, leading to an uneven movement of the handrail, which is unpleasant for the user. In addition, most regulations, such as the EN115 standard, prohibit a handrail speed that is slower than the conveyor belt speed. CN 216004891U, JP2005324968A, JPS5181382A and JP2008063103A disclose handrail treatment devices for cleaning and disinfecting handrails of an escalator or moving walkway by applying an antibacterial liquid film to the surface of the handrail.

The object of the present disclosure is to provide a reliable device which may prevent the ingress of large amounts of fluid between the handrail drive wheel and the surface of the handrail that is in contact with the handrail drive wheel.

This object is achieved by an escalator or moving walkway which may have at least one revolving, moving handrail and a handrail drive comprising a handrail drive wheel.

Usually, the handrail drive wheel may be arranged in the region of a return run of the handrail, wherein the handrail can be driven by the handrail drive wheel. The escalator or moving walkway may preferably have, for each of its handrails, at least one device for removing fluids and dirt. Said device may comprise a mounting device, a wheel body with a compressible, absorbent pad, a squeezing roller, a wheel axle, and a roller axle. In the context of the present disclosure, a compressible, absorbent pad may be a layer of compressible, absorbent material arranged on the outer cylindrical surface of the wheel body. The absorbent pad may comprise of open-pored, compressible material. By way of example, felt, woven textile fibers, twisted textile fibers, foamed polymer materials, such as foam rubber or open-pored foam rubber, and the like may be suitable for this purpose.

The wheel body and the squeezing roller may be rotatably mounted in the mounting device using the wheel axle and the roller axle respectively. An axial distance between the wheel axle and the roller axle may be specified or adjusted in such a way that the absorbent pad of the wheel body may be compressed in a contact zone between the wheel body and the squeezing roller.

The device for removing fluids and dirt may be arranged in the escalator or moving walkway in such a way that the pad of the wheel body may be in contact with the same surface of the handrail as the handrail drive wheel. In other words, fluid may be removed from at least parts (strips) of the surface of the handrail that are important for the frictional engagement with the handrail drive wheel. With regard to the wheel body, the feature “contact” is to be interpreted broadly so that, on the one hand, the surface of the absorbent pad may actually be in physical contact with the surface of the handrail. On the other hand, however, the distance between the surface of the pad and the surface of the handrail may also be selected in such a way that the pad only reaches the fluid droplets or liquid film present on the surface of the handrail and absorbs these through capillary effects. In contrast, the contact between the handrail drive wheel and the surface of the handrail is always “physical” since frictional engagement may be necessary here in order to transmit the movement.

During operation, the absorbent pad may absorb the fluid that has accumulated on the surface of the handrail and may transport it to the squeezing roller by virtue of the rotating wheel body. Since the squeezing roller may compress the pad in the contact zone, the absorbed liquid may be pressed out of the pad at that location. The squeezed segment of the absorbent pad may move onward until it again reaches the surface of the handrail and can again absorb fluid there.

With regard to a direction of linear movement of the handrail, the device may be arranged immediately upstream of the handrail drive wheel in the escalator or moving walkway. If the moving walkway or escalator is to be operated in two directions, one device of the aforementioned type may be arranged on each side of the handrail drive wheel.

In one embodiment, the device may comprise an adjustment device, by which the axial distance between the roller axle and the wheel axle can be specified or adjusted. On the one hand, this may make it possible to adjust the amount of fluid that may be squeezed out of the absorbent pad. On the other hand, this may also make it possible to vary the rotational resistance caused by the squeezing roller on the wheel body. In addition, with correct adjustment, wear can be reduced, especially on the pad.

In another embodiment, the device may comprise a friction wheel which may convert a linear movement of the handrail into a rotational movement and may transmit this to the wheel body. This may take place in various ways. By way of example, the friction wheel may be arranged on the wheel axle and may be directly connected to the wheel body or may even be formed in one piece with the wheel body. The friction wheel may also be arranged on a different axle and may transmit its rotational movement to the wheel body with a transmission. The use of a friction wheel may have the advantage that the transmission of movement may not have to take place via frictional engagement with the pad. Such transmission may be achieved if the pad is pressed somewhat against the surface of the handrail and is also compressed there as a result. Depending on the pad material used, compression may reduce the pad's ability to absorb fluids.

The transmission ratio between the friction wheel and the wheel body can be predefined by the design and the geometric ratios between the diameters thereof. Of course, a desired transmission ratio can be set in either a fixed or variable manner by way of the aforementioned transmission arranged between the friction wheel and the wheel body.

In one alternative embodiment, the device may comprise a motor and/or an input shaft. The motor and/or input shaft may be intended to transmit a rotational movement to the wheel body. As a result, the rotational speed of the wheel body can be varied independently of the linear movement of the handrail. If the surface of the pad touches the surface of the handrail only very lightly or no longer touches it at all, almost no wear may occur, despite a difference in speed between the two surfaces.

In another embodiment, the device may comprise a transmission, by which a rotational movement of the wheel body may be transmitted to the squeezing roller in a predetermined transmission ratio and in an opposite direction of rotation. By using such a transmission, an optimal rotational speed of the squeezing roller relative to the rotational speed of the wheel body can be set and maintained, so that wear phenomena on the pad can also be minimized here.

In another embodiment, the device may comprise a drainage device which may be arranged beneath the squeezing roller with regard to an intended position of use of the device in an escalator or moving walkway and in relation to the direction of gravity. As a result, the fluid squeezed out of the pad can be drained to a desired location, so that it can no longer get back onto the surface of the handrail.

Furthermore, the device may have a guide device. By virtue of the guide device, fluid which may have accumulated on the surface of the handrail but which cannot be reached by the pad can be directed toward the pad of the wheel body.

Not only is it possible for fluid to accumulate on the surface of the handrail, but dirt particles may also be present. These dirt particles may originate from the environment or from wear processes on parts of escalators or moving walkways and likewise may have an effect on the friction conditions between the handrail drive wheel and the handrail.

Since the absorbent pad may be compressible and therefore “soft,” the dirt particles may easily be pressed into the surface thereof and thus adhere there. In another embodiment, the device therefore may comprise a brush, which may be fastened to the mounting device in such a way as to be adjustable relative to the absorbent pad of the wheel body. Preferably, the dirt particles which may be removed by the brush may also be conveyed into the drainage device described above. This may be achieved by suitably shaping the brush (for example, in the manner of a wedge-shaped plough) taking into account the rotational movement of the pad relative to the stationary brush.

To ensure that the return run of the handrail is safely guided within the escalator or moving walkway, usually a plurality of support rollers or sliding guides may be provided. One of the support rollers or one of the sliding guides may be assigned to the handrail drive or to the device.

If the handrail drive or the device has a sliding guide for the handrail, the guide surfaces of the sliding guide may extend parallel to the direction of movement of the handrail. In the intended position of use, the wheel axle of the device may be oriented orthogonal to the direction of movement of the handrail, and the sliding guide may be arranged on the same side of the handrail as the wheel body.

If the handrail drive or the device has a support roller for the handrail, the support roller may be rotatably mounted in the escalator or moving walkway with its support roller axle, arranged parallel to an axis of rotation of the handrail drive wheel. The wheel axle of the device may be oriented parallel to the support roller axle and to the axis of rotation, and the handrail may be guided between the support roller and the wheel body.

Depending on the materials used for the pad, such as felt, for example, it may not be advisable to compress the pad during fluid absorption. However, a slight compression may be advantageous in the case of foamed polymer materials, such as foam rubber or open-pored foam rubber. Preferably, therefore, the device may comprise an adjustment device, by which a distance between the wheel axle and the support roller axle can be adjusted. The fluid absorption of the pad can thereby be optimized, for example, by slightly compressing the pad in the region of contact with the handrail in order then to achieve a suction effect into the interior of the pad when the compression of the pad is released.

In another embodiment, the escalator or moving walkway may have a monitoring sensor directed toward the pad for monitoring the physical condition of the pad. The measurement data from the monitoring sensor may be transmitted continuously or periodically to a controller of the escalator or moving walkway. These measurement data can be processed in the controller, with condition criteria being stored in the controller, against which the prepared and processed measurement data may be compared. The processing of measurement data to achieve data that can be compared against condition criteria has been known for years, which is why it is not explained in detail in the present disclosure. Travel stop commands and/or maintenance requests and/or warning messages can be output, depending on the result of a comparison of the measurement data against the condition criteria.

Preferred example embodiments of the invention are explained in greater detail in the following description with reference to the accompanying drawings; identical elements are provided with the same reference signs in all figures. Neither the drawings nor the description are to be interpreted as limiting the invention. In the drawings:

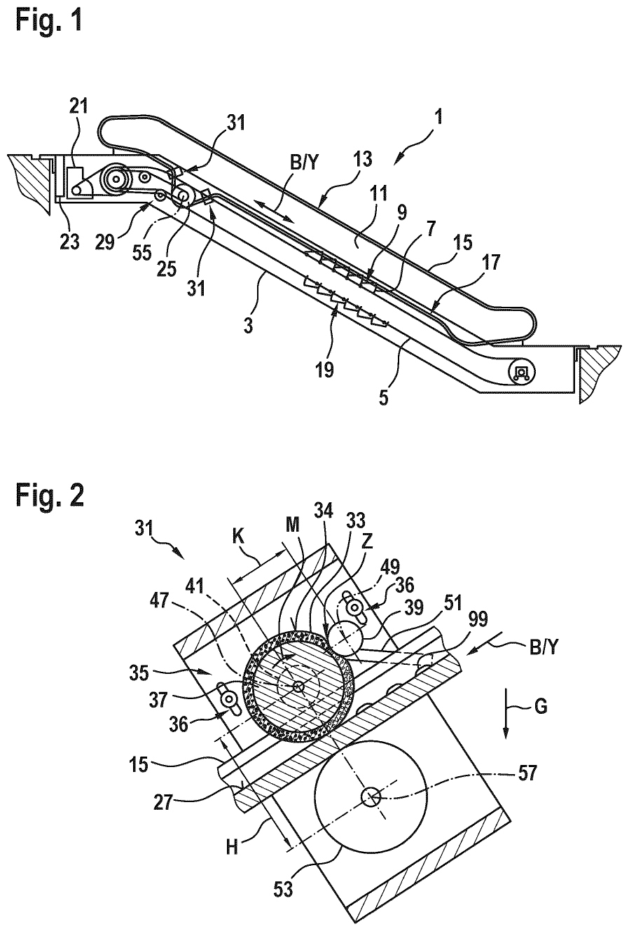

FIG. 1: shows schematically, in a sectional side view, an escalator having a revolving handrail and having a device for removing fluids and dirt from this handrail;

FIG. 2: shows, in an enlarged, sectional side view, the device shown in FIG. 1 in a first embodiment variant;

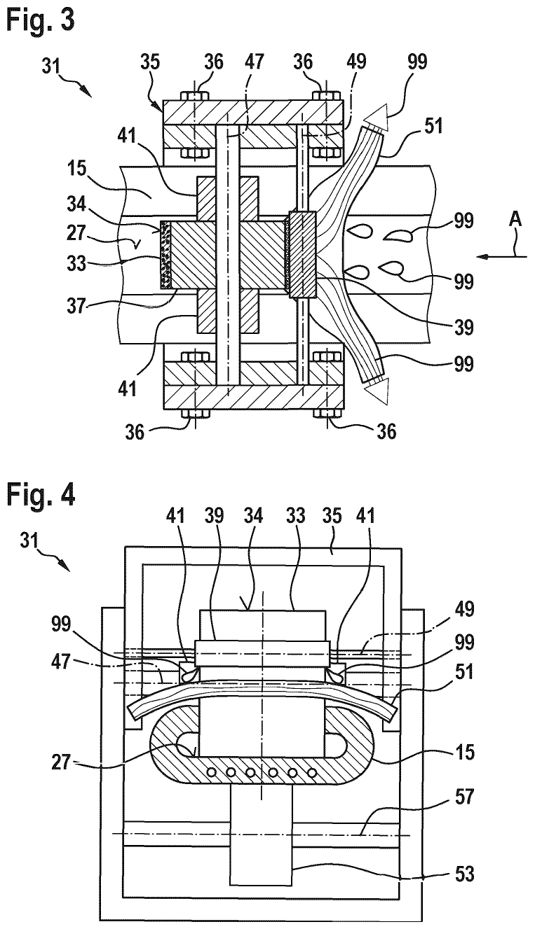

FIG. 3: shows, in a sectional plan view, the device shown in FIG. 2, wherein a wheel axle and a roller axle of the device are arranged in the sectional plane;

FIG. 4: shows a front view of the device shown in FIG. 2; and

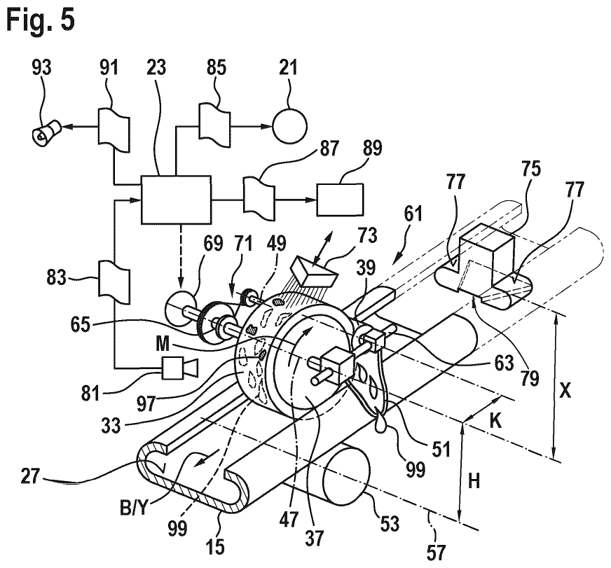

FIG. 5: shows, in a three-dimensional view, a device in a second embodiment variant.

FIG. 1 shows schematically, in a sectional side view, an escalator 1 having a supporting structure 3, in which a conveyor belt 5 comprising steps 7 (shown in part) is arranged in a revolving manner. Furthermore, on each side of the conveyor belt 5, a balustrade 11 is arranged on the supporting structure 3 (just one balustrade 11 is visible on account of the sectional side view). A handrail 15 is arranged in a revolving manner on each of these balustrades 11. The forward run 13 of the handrail may be intended to move in the same direction and at the same speed as the walkable run 9 of the conveyor belt 5. The return runs 17 of the handrails 15 and the return run 19 of the conveyor belt 5 may be guided inside the supporting structure 3, so that they are hidden from the users. A drive unit 21 and a controller 23 are also arranged in the supporting structure 3. Also accommodated in the supporting structure 3 is a handrail drive 29, which has a handrail drive wheel 25 for each handrail 15. The drive unit 21 may be connected to the conveyor belt 5 and to the respective handrail drive wheel 25 in such a way as to transmit motion.

In order to achieve sufficient traction between the handrail 15 and the handrail drive wheel 25, the handrail 15 may partially wrap around the handrail drive wheel 25. Provided in each of the two regions of the handrail 15 adjacent to where it may partially wrap around is a device 31 for removing fluids 99 and dirt 97 (see FIG. 5). Providing two devices 31 for each handrail 15 means that the escalator 1 may be intended to be operated in two opposite directions of movement Y. If just one direction of movement Y is intended, the device 31 may be arranged immediately upstream of the handrail drive wheel 25, considering the direction of movement Y of the handrail 15.

FIG. 2 shows, in an enlarged, sectional side view, the device 31 shown in FIG. 1 in a first embodiment variant. FIG. 3 shows the device 31 shown in FIG. 2 in a sectional plan view, and FIG. 4 shows a front view of the device 31 from the viewing direction A indicated in FIG. 3. These three figures will be jointly described below.

The device 31 for removing fluids 99 and dirt comprises a mounting device 35, a wheel body 37 with a compressible, absorbent pad 33, a squeezing roller 39, a wheel axle 47, and a roller axle 49. The wheel body 37 and the squeezing roller 39 are rotatably mounted in the mounting device 35 using the wheel axle 47 and the roller axle 49 respectively. Here, an axial distance K between the wheel axle 47 and the roller axle 49 may be specified or set in such a way that the absorbent pad 33 of the wheel body 37 may be compressed between the wheel body 37 and the squeezing roller 39 in a contact zone Z.

So that the handrail 15 may reach the handrail drive wheel 25 without excessive fluid and dirt, the pad 33 of the wheel body 37 may be in contact with the same surface 27 of the handrail 15 as the handrail drive wheel 25. Fluid 99 and dirt 97 may thus continuously be removed from this surface 27 by the device 31.

Two friction wheels 41 are arranged on the wheel axle 47 on each side of the wheel body 37 and are fixedly connected to the wheel body 37. The friction wheels 41 may convert a linear movement B of the handrail 15 into a rotational movement M and transmit this to the wheel body 37. This may have the advantage that the transmission of the rotational movement M may not have to take place via the pad 33, which may cause increased wear. As can be seen from this embodiment, due to the transmission ratio created by the geometric conditions, the cylindrical surface 34 of the pad 33 may move faster than the surface 27 of the handrail that is in contact with it. In order to minimize wear, the pad 33 should pass over the surface 27 of the handrail 15 with as little compression as possible, or even without contact.

The pad 33 soaked with fluid 99 may be compressed by the squeezing roller 39, so that the previously absorbed fluid 99 may be continuously squeezed out of the pad 33. To prevent the squeezed-out fluid 99 from flowing back onto the surface 27 of the handrail 15, the device 31 may comprise a drainage device 51. The drainage device is arranged beneath the squeezing roller 39 with regard to an intended position of use of the device 31 in the escalator 1 or moving walkway and in relation to the direction of gravity G.

To ensure that the handrail 15 is always in the correct position relative to the pad 33, the handrail drive 29 or the device 31 may comprise a support roller 53 for the handrail 15. The support roller 53 is rotatably mounted in the escalator 1 or moving walkway with its support roller axle 57. The wheel axle 47 of the wheel body 37 may be arranged parallel to the support roller axle 57 and to an axis of rotation 55 of the handrail drive wheel 25 (see FIG. 1). The handrail 15 may be guided between the support roller 53 and the wheel body 37. Preferably, the device 31 may comprise an adjustment device 36, by which a distance H between the wheel axle 47 and the support roller axle 57 can be adjusted. Given a suitable pad material, the fluid absorption of the pad 33 can be optimized by slightly compressing the pad 33 in the region of contact with the handrail 15 in order to achieve a suction effect into the interior of the pad when the compression of the pad is released.

FIG. 5 shows, in a schematic, three-dimensional view, a device 61 in a second embodiment variant. For the sake of clarity, the mounting device is not shown. To enable the compression of the pad 33 to be adjusted, the device 61 may comprise an adjustment device 63, by which the axial distance K between the roller axle 49 and the wheel axle 47 can be adjusted.

In a manner differing from the device 31 described above, the device 61 of FIG. 5 may not comprise a friction wheel 41, but instead may comprises a motor 69 and/or an input shaft 65, wherein the motor 69 or the input shaft 65 may be intended to transmit a rotational movement M to the wheel body 37. Instead of being connected to the motor 69, the input shaft 65 may also be connected to a transmission mechanism (not shown) which may transmit a rotational movement M of the drive unit 21 (see FIG. 1) to the wheel body 37.

The device 61 shown in FIG. 5 may additionally comprise a transmission 71. This transmission 71 may serve to transmit a rotational movement M of the wheel body 37 to the squeezing roller 39 in a predetermined transmission ratio and in an opposite direction of rotation. Since the squeezing roller 39 may compress the pad 33, the speed of revolution of the pad surface may change in the contact zone Z, and this may cause relative movements between the surface of the pad 33 and the surface of the squeezing roller 39. In order to keep these relative movements and thus wear phenomena on the pad 33 as small as possible, the transmission ratio may, for example, be selected such that a speed of revolution of the squeezing roller 39 may match a reduced speed of revolution of the pad 33 in order to minimize differences in speed at the surfaces of the pad 33 and the squeezing roller 39 caused by the compression of the absorbent pad 33.

Furthermore, the device 61 has a brush 73, which may be fastened to the mounting device 35 in such a way as to be adjustable relative to the absorbent pad 33 of the wheel body 37. The shape of the brush 73 may be selected such that, by virtue of the rotational movement M of the pad 33 relative to the stationary brush 73, the dirt particles 97 removed by the brush 73 may also be conveyed into the drainage device 51 described above. The dirt particles 97 conveyed into the drainage device 51 may be washed away by the squeezed-out fluid 99.

Instead of or in addition to the support roller 53 already described herein, the handrail drive 29 or the device 61 may have a sliding guide 75 for the handrail 15. The guide surfaces 77 thereof may be arranged parallel to the longitudinal extension or direction of movement Y of the handrail 15 in the escalator 1 or moving walkway. The wheel axle 47 of the device 61 may be arranged orthogonal to the direction of movement Y of the handrail 15. The sliding guide 75 may be arranged on the same side of the handrail 15 as the wheel body 37. Similarly to the distance H of the support roller 53, a distance X between the guide surfaces 77 and the wheel axle 47 may preferably also be adjustable.

As can be seen from FIG. 5, the surface 27 of the handrail 15 may be wider than the pad 33. The device 61 may therefore have a guide device 79. By virtue of the guide device 79, fluid 99 which may have accumulated on the surface 27 of the handrail 15 but which is not reached by the pad 33 of the wheel body 37 can be directed toward the pad 33. In the present embodiment, the guide device 79 may be integrated in the sliding guide 75. Of course, a guide device 79 may, for example, be provided with guide plates or displacement rollers. The guide device 79 also may not have to be part of the sliding guide 75.

The device 61 shown in FIG. 5 has a monitoring sensor 81 directed toward the pad 33 which may be configured for monitoring the physical condition of the pad 33. The monitoring sensor 81 used may be any type of sensor, such as optical sensors, distance sensors, proximity sensors and the like, which can detect, for example, dissolution phenomena of the pad 33. In the present embodiment, the measurement data 83 from the monitoring sensor 81 may be transmitted to the controller 23 of the escalator 1 or moving walkway. The measurement data 83 may be processed in the controller 23 and may be compared against condition criteria (not shown). If the detected condition no longer corresponds to the specified condition criteria, a travel stop command 85 can be output to the drive 21 or the motor 69 and/or maintenance requests 87 can be output to a maintenance center 89 and/or warning messages 91 can be output to a communication unit 93, depending on the detected condition.

Although the disclosure has been described herein by illustrating specific embodiments, numerous other embodiment variants can be implemented according to the present disclosure, for example, by using also in the first embodiment variant one or more features that are only illustrated and described in the second embodiment variant.

1.-14. (canceled)

15. An escalator or a moving walkway comprising:
at least one handrail comprising a handrail drive and a handrail drive wheel, wherein the handrail drive wheel is arranged in a region of a return run of the at least one handrail and wherein the handrail drive wheel is configured to drive the at least one handrail;
at least one device arranged in each of the at least one handrail configured to remove fluids and dirt, the at least one device comprising:
a mounting device;
a wheel body with an absorbent pad configured to compress;
a squeezing roller;
a wheel axle; and
a roller axle,
wherein the wheel body and the squeezing roller are rotatably mounted in the mounting device using the wheel axle and the roller axle respectively,
and wherein an axial distance between the wheel axle and the roller axle is specified or adjusted in such a way that the squeezing roller compresses the absorbent pad in a contact zone, and
wherein the absorbent pad of the wheel body is in contact with a same surface of the at least one handrail as the handrail drive wheel.

16. The escalator or the moving walkway of claim 15, wherein the at least one device is arranged immediately upstream of the handrail drive wheel with respect to a direction of movement of the at least one handrail.

17. The escalator or the moving walkway of claim 15, wherein the at least one device is arranged on each side of the handrail drive wheel with respect to two possible directions of movement of the at least one handrail.

18. The escalator or the moving walkway of claim 16, wherein the at least one device is arranged on each side of the handrail drive wheel with respect to two possible directions of movement of the at least one handrail.

19. The escalator or the moving walkway of claim 15, wherein the at least one device further comprises an adjustment device configured to adjust the axial distance between the roller axle and the wheel axle can be adjusted.

20. The escalator or the moving walkway of claim 16, wherein the at least one device further comprises an adjustment device configured to adjust the axial distance between the roller axle and the wheel axle can be adjusted.

21. The escalator or the moving walkway of claim 15, wherein the at least one device further comprises a friction wheel configured to convert a linear movement of the at least one handrail into a rotational movement and to transmit the rotational movement to the wheel body.

22. The escalator or the moving walkway of claim 16, wherein the at least one device further comprises a friction wheel configured to convert a linear movement of the at least one handrail into a rotational movement and to transmit the rotational movement to the wheel body.

23. The escalator or the moving walkway of claim 15, wherein the at least one device further comprises at least one of a motor configured to transmit a rotational movement to the wheel body or an input shaft configured to transmit the rotational movement to the wheel body.

24. The escalator or the moving walkway of claim 16, wherein the at least one device further comprises at least one of a motor configured to transmit a rotational movement to the wheel body or an input shaft configured to transmit the rotational movement to the wheel body.

25. The escalator or the moving walkway of claim 15, wherein the at least one device further comprises a transmission configured to transmit a rotational movement of the wheel body to the squeezing roller in a predetermined transmission ratio and in an opposite direction of rotation.

26. The escalator or the moving walkway of claim 16, wherein the at least one device further comprises a transmission configured to transmit a rotational movement of the wheel body to the squeezing roller in a predetermined transmission ratio and in an opposite direction of rotation.

27. The escalator or the moving walkway of claim 15, wherein the at least one device comprises a drainage device arranged beneath the squeezing roller with respect to an intended position of use of the at least one device in the escalator or the moving walkway and in relation to the direction of gravity.

28. The escalator or the moving walkway of claim 16, wherein the at least one device comprises a drainage device arranged beneath the squeezing roller with respect to an intended position of use of the at least one device in the escalator or the moving walkway and in relation to the direction of gravity.

29. The escalator or the moving walkway of claim 15, wherein the at least one device comprises a brush fastened to the mounting device in such a way as to be adjustable relative to the absorbent pad of the wheel body.

30. The escalator or the moving walkway of claim 15, wherein the handrail drive or the at least one device comprises a sliding guide for the at least one handrail comprising guide surfaces, wherein the guide surfaces are arranged parallel to a direction of movement of the at least one handrail in the escalator or the moving walkway, wherein the wheel axle of the at least one device is arranged orthogonal to the direction of movement of the at least one handrail, and wherein the sliding guide is arranged on a same side of the at least one handrail as the wheel body.

31. The escalator or the moving walkway of claim 15, wherein the handrail drive or the at least one device further comprises a support roller for the at least one handrail rotatably mounted in the escalator or the moving walkway using a support roller axle, which is arranged parallel to an axis of rotation of the handrail drive wheel, wherein the wheel axle of the at least one device is arranged parallel to the support roller axle and to the axis of rotation, and wherein the at least one handrail is guided between the support roller and the wheel body.

32. The escalator or the moving walkway of claim 31, wherein the at least one device further comprises an adjustment device configured to adjust a distance between the wheel axle and the support roller axle.

33. The escalator or the moving walkway of claim 15, further comprising a monitoring sensor directed toward the absorbent pad for monitoring a physical condition of the absorbent pad.

34. The escalator or the moving walkway of claim 33, wherein measurement data from the monitoring sensor is transmitted to a controller of the escalator or the moving walkway, and wherein the measurement data is processed in the controller in order to output at least one of travel stop commands, maintenance requests or warning messages, depending on a result of the measurement data processing.
